(19) United States
(12) Patent Application Publication
(10) Pub. No.: US 2017/0180116 A1
(43) Pub. Date: Jun. 22, 2017

(54) END-TO-END PROTECTION SCHEME INVOLVING ENCRYPTED MEMORY AND STORAGE

(71) Applicants: Kirk S. Yap, Westborough, MA (US); Vinodh Gopal, Westborough, MA (US)

(72) Inventors: Kirk S. Yap, Westborough, MA (US); Vinodh Gopal, Westborough, MA (US)

(21) Appl. No.: 14/979,349

(22) Filed: Dec. 22, 2015

(51) Int. Cl. H04L 9/06; G09C 1/00

(52) U.S. Cl. CPC H04L 9/065; G09C 1/00; H04L 2209/12

(57) ABSTRACT

Systems, apparatuses and methods may provide for generating encrypted data based on write data received at a first data input of an apparatus and generating an inbound protection bit stream based on the write data. Additionally, write protection metadata may be generated based on the inbound protection bit stream and a first counter. In one example, decrypted data may also be generated based on read data received at a second data input of the apparatus. In such a case, a first outbound protection bit stream may be generated based on the decrypted data, and a second outbound protection bit stream may be generated based on a second counter and outbound protection metadata. Moreover, an error signal may be generated in response to a difference between the first outbound protection bit stream and the second outbound protection bit stream.

### TECHNICAL FIELD

Embodiments generally relate to memory structures. More particularly, embodiments relate to end-to-end protection schemes involving encrypted memory and storage.

### BACKGROUND

Datacenters may be used in high performance computing (HPC), big data solutions and other architectures involving relatively high bandwidth data transfers to and from memory. Accordingly, the performance of conventional datacenters may be particularly sensitive to read latencies, wherein achieving end-to-end protection against errors that may occur along the data path may present further challenges to the use of high bandwidth memory. More particularly, datacenter operations may involve encrypting and decrypting data in order to enhance security in architectures involving non-volatile memory (NVM). However, data transformations that naturally occur during the encryption and decryption of data may render conventional error protection techniques inapplicable.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a datapath protection apparatus according to an embodiment;

FIG. 2A is a block diagram of an example of a portion of a write path according to an embodiment;

FIG. 2B is a block diagram of an example of a portion of a read path according an embodiment;

FIG. 3A is a flowchart of an example of a method of operating a write path according to an embodiment;

FIG. 3B is a flowchart of an example of a method of operating a read path according to an embodiment; and

FIG. 4 is a block diagram of an example of a computing system according to an embodiment.

### DESCRIPTION OF EMBODIMENTS

One approach to addressing data security may be to use cyclic redundancy check (CRC) techniques to generate protection bits for plaintext data (e.g., data being written to memory and/or storage) prior to encryption of the data. When the encrypted data is retrieved and decrypted, the CRC protection bits may be used to detect errors in the encryption, write, read and/or decryption processes. In such a solution, however, an attacker may use the CRC protection bits to infer information and/or characteristics of the plaintext data that would weaken/defeat the purpose of encrypting the plaintext data.

Another approach may be to use cryptographic hashing techniques to generate a message authentication code (MAC) and/or message digest for the plaintext data. Although such an approach may not compromise the confidentiality provided by encryption of the plaintext data, the computational complexity of cryptographic hashing may have a negative impact on read and write latencies, as well as semiconductor real estate.

Recent developments in memory architectures may provide for non-volatile memory (NVM) that is used to store volatile data considered to be stored in a volatile memory. For example, such volatile data may include, for example, data used by an application or operating system, that the application or operating system considers to be stored in a volatile memory and is no longer stored in the volatile memory after a system reset. Examples of NVM may include, for example, block addressable memory device, such as NAND or NOR technologies, phase change memory (PCM), three dimensional cross point memory, or other byte addressable nonvolatile memory devices, memory devices that use chalcogenide phase change material (e.g., chalcogenide glass), resistive memory, nanowire memory, ferro-electric transistor random access memory (FeTRAM), flash memory such as solid state disk (SSD) NAND or NOR, multi-threshold level NAND flash memory, NOR flash memory, magnetoresistive random access memory (MRAM) memory that incorporates memristor technology, spin transfer torque (STT)-MRAM, or a combination of any of the above, or other memory. These memory structures may be particularly useful in datacenter environments such as, for example, high performance computing (HPC) systems, big data systems and other architectures involving relatively high bandwidth data transfers.

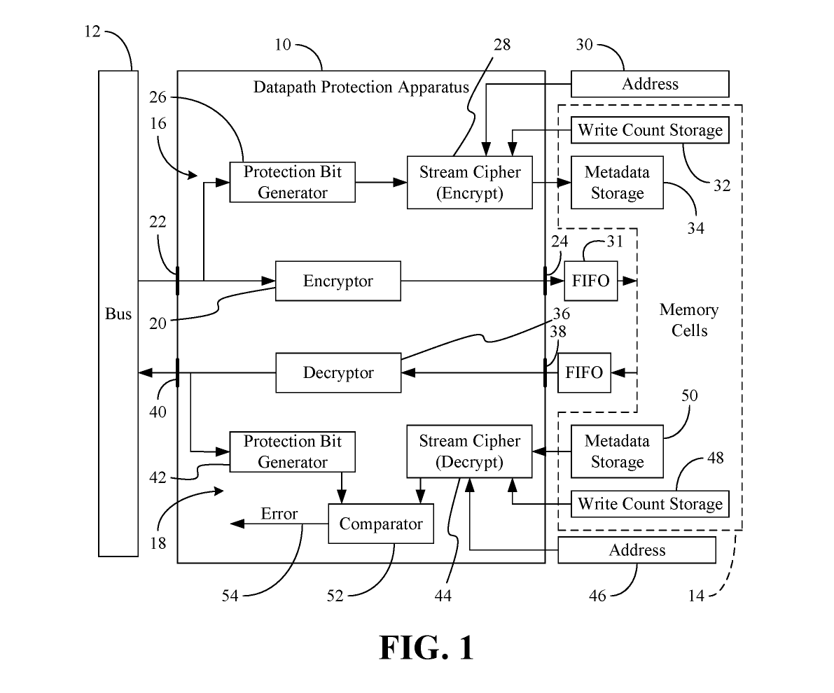

Turning now to FIG. 1, a datapath protection apparatus 10 is shown in which the apparatus 10 is coupled to a bus 12 (e.g., double data rate/DDR bus) and a memory structure containing a plurality of memory cells 14. The memory cells 14 may include, for example, NVM that is used to store data, including volatile data. In one example, data is written to the memory cells 14 via the bus 12 and a write path 16 by way of relatively high bandwidth data transfers (e.g., 16B/cycle at 800 MHz). Similarly, data may be read from the memory cells 14 via a read path 18 and the bus 12 by way of high bandwidth data transfers. In general, the apparatus 10 may provide end-to-end protection against security breaches and errors for the data stored in the memory cells 14. The protection may be considered end-to-end to the extent that security breaches and errors may accounted for from the entire datapath between the bus 12 and the memory cells 14.

More particularly, the write path 16 may include an encryptor 20 coupled to a first data input 22 and a first data output 24 of the apparatus 10. Encryptor 20 may provide an Advanced Encryption Standard XOR-encrypt-XOR based tweaked-codebook mode with ciphertext stealing/AES-XTS capability and/or combinational logic. The encryptor 20 may generate encrypted data based on write data received at the first data input 22. The encryptor 20 may use block mode encryption (e.g., operating on 16-Byte blocks of write data) to generate the encrypted data. Encryption of other sizes of write data may take place.

Additionally, a first protection bit generator 26 may be coupled to the first data input 22. The first protection bit generator 26 may generate an inbound protection bit stream based on the write data. As will be discussed in greater detail, the first protection bit generator 26 may be a parity generator (e.g., that operates on temporally close data), a cyclic redundancy check (CRC) generator, and so forth. The write path 16 may also include a first stream cipher 28 coupled to the first protection bit generator 26, wherein the first stream cipher 28 uses counter mode encryption to generate write protection metadata.

For example, if the first protection bit generator 26 is a parity generator, each bit of the inbound protection bit stream may indicate whether the number of bits having the value one in a particular block is even or odd (e.g., the inbound protection bit stream includes a single protection bit per block of the encrypted data). In another example, if the inbound protection bit stream includes a plurality of protection bits per block of the encrypted data, the protection bit generator 26 might include a parity generator and/or a cyclic redundancy checker. The cyclic redundancy checker may have a relatively complex burst error protection capability that determines the remainder of a polynomial division of each block. In this regard, due to the nature of encryption, a single bit error in encrypted data may tend to cause a significantly large number of subsequent bits to toggle. As a result, the encryptor 20 might exhibit an error spreading behavior that renders the burst error protection capability of CRC irrelevant. Accordingly, the use of parity in the protection bit generator 26 may be advantageous in dealing with errors occurring in the encryptor 20. Other protection bit generation techniques may also be used.

The inbound protection metadata may be generated based on the inbound protection bit stream, a write address 30 associated with the write data, and a write count associated with the write data. The address 30 and the write count may be combined (e.g., via concatenating data, appending data, etc.) to form a unique counter value that the first stream cipher 28 uses to perform counter mode encryption on the inbound protection bit stream. In the illustrated, the write count is retrieved from write count storage 32 and the inbound protection metadata is written to metadata storage 34, wherein the write count storage 32 and the metadata storage 34 may reside in the memory cells 14. Of particular note is that if the memory cells 14 include NVM that is used to store volatile data, the write count storage 32 may already exist in order to monitor the aging of the memory cells 14. Accordingly, the illustrated solution may enable the use of counter mode encryption without imposing any additional storage overhead. Write count storage 32 may be external to memory cells 14 in a separate memory device.

The read path 18 of the datapath protection apparatus 10 may include a decryptor 36 (e.g., having AES-XTS capability) coupled to a second data input 38 and a second data output 40 of the apparatus 10. The decryptor 36 may use block mode encryption (e.g., operating on 16-Byte blocks of read data) to generate decrypted data based on read data received at the second data input 38.

Additionally, a second protection bit generator 42 may be coupled to the second data output 40, wherein the second protection bit generator 42 generates a first outbound protection bit stream based on the decrypted data. The second protection bit generator 42 may include a parity generator and/or a cyclic redundancy checker, as already discussed. The illustrated apparatus 10 also includes a second stream cipher 44 to generate a second outbound protection bit stream based on a read address 46 associated with the read data, a write count associated with the read address, and outbound protection metadata associated with the read address 46.

In the illustrated, the write count is retrieved from write count storage 48 and the outbound protection metadata is retrieved from metadata storage 50, wherein the write count storage 48 and the metadata storage 50 may reside in the memory cells 14. The address 46 and the write count may be combined to form a unique counter value that the second stream cipher 44 uses to perform counter mode decryption on the outbound protection metadata. If the memory cells 14 include NVM that is used to store volatile data, the write count storage 48 may also already exist in order to monitor the aging of the memory cells 14. Accordingly, the illustrated solution may further enable the use of counter mode encryption without imposing any additional storage overhead. Write count storage 48 may be external to memory cells 14 in a separate memory device. Moreover, the write count storage 32, 48 may share a common region in the memory cells 14 and the metadata storage 34, 50 may share a common region in the memory cells 14.

Additionally, a comparator 52 (e.g., XOR) may be coupled to the second protection bit generator 42 and the second stream cipher 44. The comparator 52 may be configured to generate an error signal 54 in response to a difference being detected between the first outbound protection bit stream and the second outbound protection bit stream. The comparator 52 may determine whether to generate the error signal 54 per each block of the decrypted data. In this regard, each block of decrypted data may be sent to the bus 12 as soon as the comparator 52 confirms that there is no difference between the first outbound protection bit stream and the second outbound protection bit stream. As a result, the read latency of the illustrated solution may be substantially reduced. Moreover, the end-to-end protection provided by the illustrated solution may account for security breaches and/or errors in the encryptor 20 and the decryptor 36, as well in other components in the datapath such as, for example, a first-in-first-out (FIFO) buffer 31 in the write path, a FIFO buffer 33 in the read path, error correction code (ECC) components (not shown), and so forth.

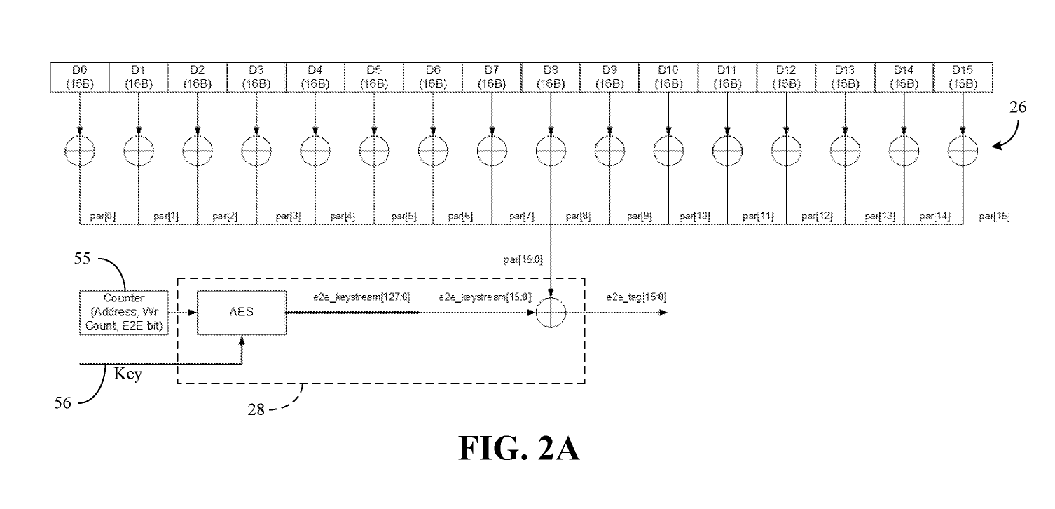

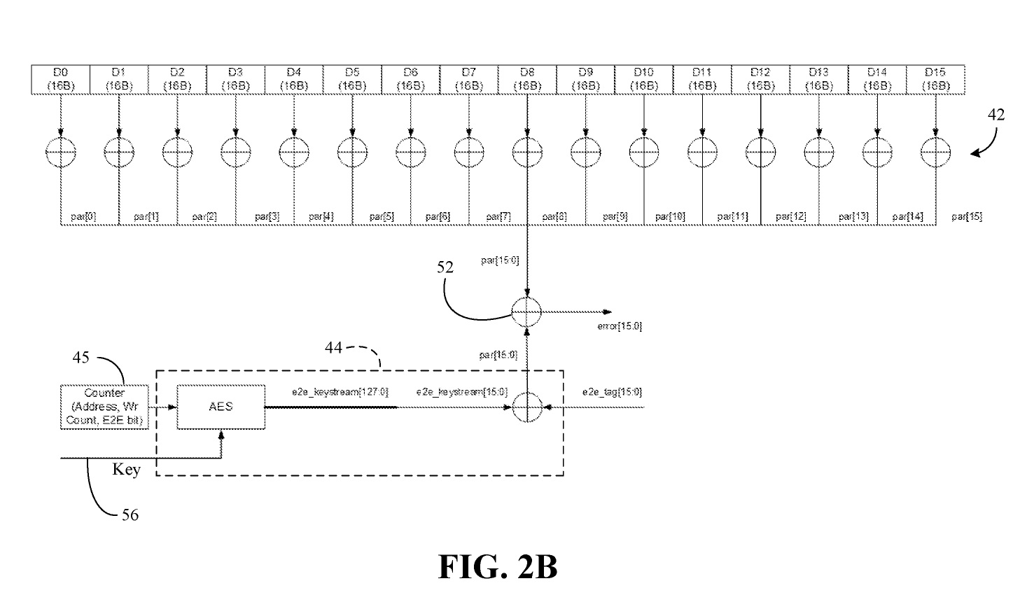

FIG. 2A shows a more detailed write example in which the first protection bit generator 26 includes a parity generator that produces a single parity bit for each 16B block of write data. Accordingly, a 16-bit protection tag may be allocated to protect 256B of data (e.g., each 16B block of data is protected by a bit of parity, independent of the other blocks). Moreover, the illustrated parity bits are generated before the data is encrypted. At the start of the encryption, a counter 55 may be formed from the address and write count of the particular memory location. The first stream cipher 28 may then use a key 56 (e.g., end-to-end AES key) to encrypt the counter 55 and obtain a 16B keystream (e.g., “e2e_keystream[15:0]”). In one example, only a fraction of the entire keystream is used to encrypt the protection bits (e.g., 16 bits in the example shown). Other numbers of bits of the keystream can be used to encrypt the protection bits. The resulting encrypted protection bits (e.g., “e2e_tag[15:0]”) may be stored together with the other metadata associated with the data being written to memory. The illustrated scheme may be extended provide a plurality of parity bits per block (e.g., 32 bits of protection with 4 independent bits per 16B block or other numbers of bits of protection), as long as each block is handled independently from the remaining blocks to minimize latency. For example, each data block may alternatively be processed by a CRC generator.

FIG. 2B shows a more detailed read example in which the second protection bit generator 42 includes a parity generator that produces a single parity bit for each 16B block of read data. During a read operation, the encryption of a counter 45 may be immediately started as soon as the write count becomes available, wherein the counter encryption may occur in parallel with the decryption of the data. Upon completion of the encryption of the counter 45, the illustrated keystream is XORed with the stored protection bits (e.g., “e2e_tag[15:0]”). Once the first 16B block of data has been decrypted, a parity bit is generated and compared against the corresponding decrypted protection bit. In the illustrated example, the comparator 52 is implemented as a simple XOR that may introduce a minimal/negligible delay into the read path. An error may be generated accordingly when a parity mismatch occurs.

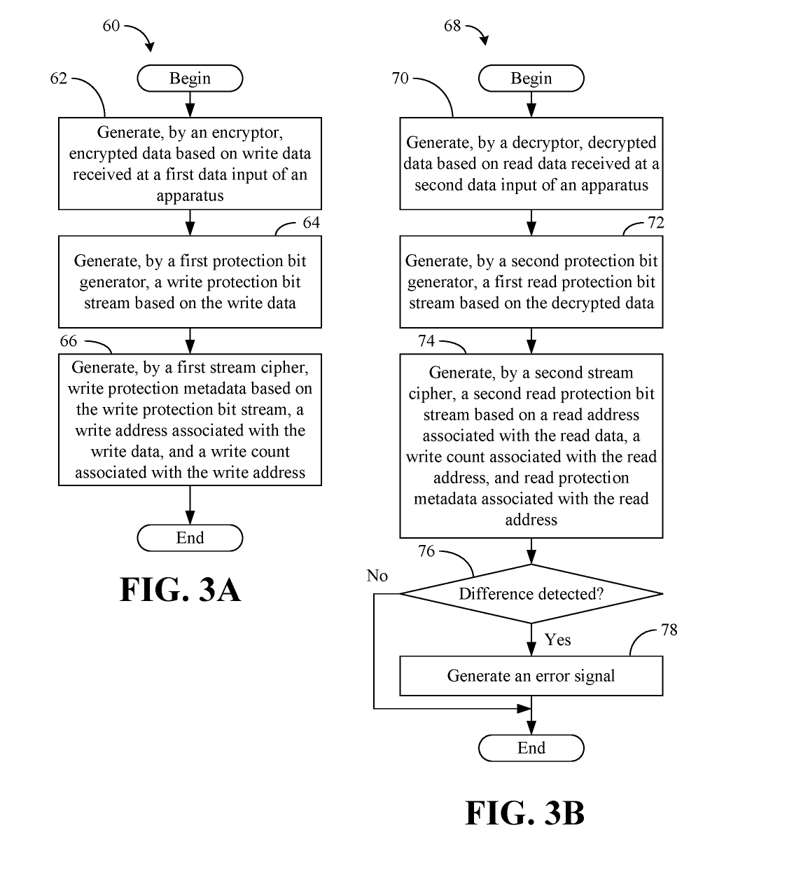

FIG. 3A shows a method 60 of operating a write path. The method 60 may generally be implemented in a datapath protection apparatus such as, for example, the datapath protection apparatus 10 (FIG. 1), already discussed. More particularly, the method 60 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof. For example, computer program code to carry out operations shown in method 60 may be written in any combination of one or more programming languages, including an object oriented programming language such as JAVA, SMALLTALK, C++ or the like and conventional procedural programming languages, such as the “C” programming language or similar programming languages.

Illustrated processing block 62 provides for generating, by an encryptor, encrypted data based on write data received at a first input of an apparatus. Additionally, block 64 may generate, by a first protection bit generator, an inbound protection bit stream based on the write data. In one example, the first protection bit generator includes a parity generator and the inbound protection bit stream includes a single protection bit per block of the encrypted data. In another example, the first protection bit generator includes a parity generator and/or a cyclic redundancy checker and the inbound protection bit stream includes a plurality of protection bits per block of the encrypted data. Illustrated block 66 generates, by a first stream cipher, write protection metadata based on the inbound protection bit stream, a write address associated with the write data, and a write count associated with the write address.

FIG. 3B shows a method 68 of operating a read path. The method 68 may generally be implemented in a datapath protection apparatus such as, for example, the datapath protection apparatus 10 (FIG. 1), already discussed. More particularly, the method 68 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 70 provides for generating, by a decryptor, decrypted data based on read data received at a second input of an apparatus. A first outbound protection bit stream may be generated, by a second protection bit generator, at block 72 based on the decrypted data. The first outbound protection bit stream may be generated by a parity generator, a cyclic redundancy checker, etc., or any combination thereof. Additionally, illustrated block 74 generates, by a second stream cipher, a second outbound protection bit stream based on a read address associated with the read data, a write count associated with the read address, and outbound protection metadata associated with the read address.

A determination may be made at block 76 as to whether there is a difference between the first outbound protection bit stream and the second outbound protection bit stream. If so, illustrated block 78 generates an error signal. Otherwise, the illustrated method 68 bypasses block 78. The determination at block 76 may be made per each block of decrypted data. Accordingly, the absence of the error signal may enable faster transfer of read data (e.g., reduced read latency).

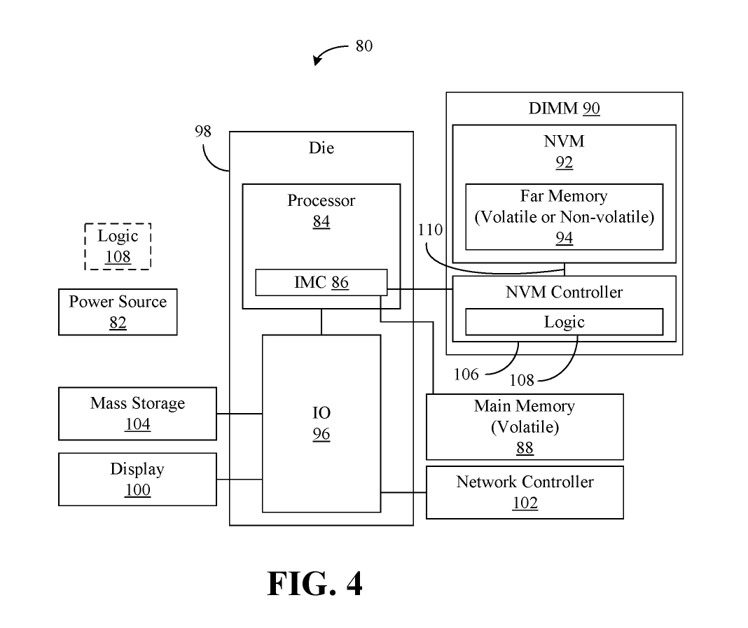

FIG. 4 shows an integrity-enhanced computing system 80. The computing system 80 may generally be part of an electronic device/platform having computing functionality (e.g., datacenter, server, personal digital assistant/PDA, notebook computer, tablet computer), communications functionality (e.g., smart phone), imaging functionality, media playing functionality (e.g., smart television/TV), wearable functionality (e.g., watch, eyewear, headwear, footwear, jewelry), vehicular functionality (e.g., car, truck, motorcycle), etc., or any combination thereof. In the illustrated example, the system 80 includes a power source 82 to supply power to the system 80 and a processor 84 having an integrated memory controller (IMC) 86 that is coupled to main memory 88 (e.g., volatile “near” memory). The IMC 86 may also be coupled to another memory module 90 (e.g., dual inline memory module/DIMM) containing a non-volatile memory structure such as, for example, NVM 92. The NVM 92 may include “far” memory 94, which may also be used to store volatile data. Thus, the far memory 94 and the main memory 88 may function as a two-level memory (2LM) structure, wherein the main memory 88 generally serves as a low-latency and high-bandwidth cache of the far memory 94.

The NVM 92 may include any of the examples of non-volatile memory devices listed earlier. As already noted, the memory module 90 may include volatile memory, for example, DRAM configured as one or more memory modules such as, for example, DIMMs, small outline DIMMs (SODIMMs), etc. Examples volatile memory include dynamic volatile memory includes DRAM (dynamic random access memory), or some variant such as synchronous DRAM (SDRAM).

A memory subsystem as described herein may be compatible with a number of memory technologies, such as DDR4 (DDR version 4, initial specification published in September 2012 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (LPDDR version 5, currently in discussion by JEDEC), HBM2 (HBM version 2, currently in discussion by JEDEC), and/or others, and technologies based on derivatives or extensions of such specifications.

The illustrated system 80 also includes an input output (IO) module 96 implemented together with the processor 84 on a semiconductor die 98 as a system on chip (SoC), wherein the IO module 96 functions as a host device and may communicate with, for example, a display 100 (e.g., touch screen, liquid crystal display/LCD, light emitting diode/LED display), a network controller 102, and mass storage 104 (e.g., hard disk drive/HDD, optical disk, flash memory, etc.). The memory module 90 may include an NVM controller 106 having logic 108 that is connected to the far memory 94 via an internal bus 110 or other suitable interface. The illustrated logic 108 may function similarly to the datapath protection apparatus 10 (FIG. 1) and may implement one or more aspects of the method 60 (FIG. 3A) and/or the method 68 (FIG. 3B), already discussed. The logic 108 may alternatively be implemented elsewhere in the system 80.

### Additional Notes and Examples

Example 1 may include an integrity-enhanced computing system comprising a memory, a bus and a datapath protection apparatus coupled to the memory and the bus, the datapath protection apparatus comprising a write path including an encryptor coupled to a first data input and a first data output of the apparatus, the encryptor to generate encrypted data based on write data received at the first data input, a first protection bit generator to generate an inbound protection bit stream based on the write data, and a first stream cipher coupled to the first protection bit generator, the first stream cipher to generate write protection metadata based on the inbound protection bit stream, a write address associated with the write data, and a write count associated with the write address.

Example 2 may include the system of Example 1, wherein the first protection bit generator includes a parity generator and the inbound protection bit stream is to include a single protection bit per encryption block of the encrypted data.

Example 3 may include the system of Example 1, wherein the first protection bit generator includes one or more of a parity generator or a cyclic redundancy checker and the inbound protection bit stream is to include a plurality of protection bits per encryption block of the encrypted data.

Example 4 may include the system of Example 1, wherein the datapath protection apparatus further comprises a read path including a decryptor coupled to a second data input and a second data output of the apparatus, the decryptor to generate decrypted data based on read data received at the second data input, a second protection bit generator coupled to the second data output, the second protection bit generator to generate a first outbound protection bit stream based on the decrypted data, a second stream cipher to generate a second outbound protection bit stream based on a read address associated with the read data, a write count associated with the read address, and outbound protection metadata associated with the read address, and a comparator coupled to the second protection bit generator and the second stream cipher, the comparator to generate an error signal in response to a difference between the first outbound protection bit stream and the second outbound protection bit stream.

Example 5 may include the system of Example 4, wherein the second protection bit generator includes one or more of a parity generator or a cyclic redundancy checker.

Example 6 may include the system of any one of Examples 4 or 5, wherein the comparator is to determine whether to generate the error signal per each encryption block of the decrypted data.

Example 7 may include the system of Example 1, further comprising one or more of a processor communicatively coupled to the memory, a display communicatively coupled to the memory, a network interface communicatively coupled to a processor, or a battery communicatively coupled to a processor.

Example 8 may include a datapath protection apparatus comprising a write path including an encryptor coupled to a first data input and a first data output of the apparatus, the encryptor to generate encrypted data based on write data received at the first data input, a first protection bit generator coupled to the first data input, the first protection bit generator to generate an inbound protection bit stream based on the write data, and a first stream cipher coupled to the first protection bit generator, the first stream cipher to generate write protection metadata based on the inbound protection bit stream, a write address associated with the write data, and a write count associated with the write address.

Example 9 may include the apparatus of Example 8, wherein the first protection bit generator includes a parity generator and the inbound protection bit stream is to include a single protection bit per encryption block of the encrypted data.

Example 10 may include the apparatus of Example 8, wherein the first protection bit generator includes one or more of a parity generator or a cyclic redundancy checker and the inbound protection bit stream is to include a plurality of protection bits per encryption block of the encrypted data.

Example 11 may include the apparatus of Example 8, further including a read path including a decryptor coupled to a second data input and a second data output of the apparatus, the decryptor to generate decrypted data based on read data received at the second data input a second protection bit generator coupled to the second data output, the second protection bit generator to generate a first outbound protection bit stream based on the decrypted data, a second stream cipher to generate a second outbound protection bit stream based on a read address associated with the read data, a write count associated with the read address, and outbound protection metadata associated with the read address, and a comparator coupled to the second protection bit generator and the second stream cipher, the comparator to generate an error signal in response to a difference between the first outbound protection bit stream and the second outbound protection bit stream.

Example 12 may include the apparatus of Example 11, wherein the second protection bit generator includes one or more of a parity generator or a cyclic redundancy checker.

Example 13 may include the apparatus of any one of Examples 11 or 12, wherein the comparator is to determine whether to generate the error signal per each encryption block of the decrypted data.

Example 14 may include a method of operating a datapath protection apparatus, comprising generating, by an encryptor, encrypted data based on write data received at a first data input of the apparatus, generating, by a first protection bit generator, an inbound protection bit stream based on the write data, and generating, by a first stream cipher, write protection metadata based on the inbound protection bit stream, a write address associated with the write data, and a write count associated with the write address.

Example 15 may include the method of Example 14, wherein the inbound protection bit stream includes a single protection bit per encryption block of the encrypted data.

Example 16 may include the method of Example 14, wherein the inbound protection bit stream includes a plurality of protection bits per encryption block of the encrypted data.

Example 17 may include the method of Example 14, further including generating, by a decryptor, decrypted data based on read data received at a second data input of the apparatus, generating, by a second protection bit generator, a first outbound protection bit stream based on the decrypted data, generating, by a second stream cipher, a second outbound protection bit stream based on a read address associated with the read data, a write count associated with the read address, and outbound protection metadata associated with the read address, and generating, by a comparator, an error signal in response to a difference between the first outbound protection bit stream and the second outbound protection bit stream.

Example 18 may include the method of Example 17, wherein the first outbound protection bit stream is generated by one or more of a parity generator or a cyclic redundancy checker.

Example 19 may include the method of any one of Examples 17 or 18, further including determining whether to generate the error signal per each encryption block of the decrypted data.

Example 20 may include at least one non-transitory computer readable storage medium comprising a set of instructions, which when executed by a computing device, cause the computing device to generate encrypted data based on write data received at a first input of an apparatus, generate an inbound protection bit stream based on the write data, and generate write protection metadata based on the inbound protection bit stream, a write address associated with the write data, and a write count associated with the write address.

Example 21 may include the at least one non-transitory computer readable storage medium of Example 20, wherein the inbound protection bit stream is to include a single protection bit per encryption block of the encrypted data.

Example 22 may include the at least one non-transitory computer readable storage medium of Example 20, wherein the inbound protection bit stream is to include a plurality of protection bits per encryption block of the encrypted data.

Example 23 may include the at least one non-transitory computer readable storage medium of Example 20, wherein the instructions, when executed, further cause a computing device to generate decrypted data based on read data received at a second data input of the apparatus, generate a first outbound protection bit stream based on the decrypted data, and generate an error signal in response to a difference between the first outbound protection bit stream and the second outbound protection bit stream.

Example 24 may include the at least one non-transitory computer readable storage medium of Example 23, wherein the first outbound protection bit stream is to be generated by one or more of a parity generator or a cyclic redundancy checker.

Example 25 may include the at least one non-transitory computer readable storage medium of any one of Examples 23 or 24, wherein the instructions, when executed, further cause a computing device to determine whether to generate the error signal per each encryption block of the decrypted data.

Example 26 may include a method of operating a datapath protection apparatus, comprising generating, by a decryptor, decrypted data based on read data received at a data input of the apparatus, generating, by a protection bit generator, a first outbound protection bit stream based on the decrypted data, generating, by a stream cipher, a second outbound protection bit stream based on a read address associated with the read data, a write count associated with the read address, and outbound protection metadata associated with the read address, and generating, by a comparator, an error signal in response to a difference between the first outbound protection bit stream and the second outbound protection bit stream.

Example 27 may include the method of Example 26, wherein the first outbound protection bit stream is generated by one or more of a parity generator or a cyclic redundancy checker.

Example 28 may include the method of any one of Examples 26 or 27, further including determining whether to generate the error signal per each encryption block of the decrypted data.

Example 29 may include at least one non-transitory computer readable storage medium comprising a set of instructions, which when executed by a computing device, cause the computing device to perform the method of any one of Examples 26 to 28.

Example 30 may include a datapath protection apparatus comprising means for performing the method of any one of Examples 26 to 28.

Example 31 may include datapath protection apparatus comprising means for generating, by an encryptor, encrypted data based on write data received at a first data input of an apparatus, means for generating, by a first protection bit generator, an inbound protection bit stream based on the write data, and means for generating, by a first stream cipher, write protection metadata based on the inbound protection bit stream, a write address associated with the write data, and a write count associated with the write address.

Example 32 may include the apparatus of Example 31, wherein the inbound protection bit stream is to include a single protection bit per encryption block of the encrypted data.

Example 33 may include the apparatus of Example 31, wherein the inbound protection bit stream is to include a plurality of protection bits per encryption block of the encrypted data.

Example 34 may include the apparatus of Example 31, further including means for generating, by a decryptor, decrypted data based on read data received at a second data input of the apparatus, means for generating, by a second protection bit generator, a first outbound protection bit stream based on the decrypted data, means for generating, by a second stream cipher, a second outbound protection bit stream based on a read address associated with the read data, a write count associated with the read address, and outbound protection metadata associated with the read address, and means for generating, by a comparator, an error signal in response to a difference between the first outbound protection bit stream and the second outbound protection bit stream.

Example 35 may include the apparatus of Example 34, wherein the first outbound protection bit stream is to be generated by one or more of a parity generator or a cyclic redundancy checker.

Example 36 may include the apparatus of any one of Examples 34 or 35, further including means for determining whether to generate the error signal per each encryption block of the decrypted data.

Techniques described herein may therefore implement counter mode encryption with no additional storage overhead as well as generate protection bits with zero impact on main datapath latency or throughput. Moreover, end-to-end protection may be supported in systems employing encryption of memory (e.g., system memory) and storage (e.g., mass storage). The techniques may result in greater performance, lower cost and reliable security.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A system comprising:
a memory;
a bus; and
a datapath protection apparatus coupled to the memory and the bus, the datapath protection apparatus comprising a write path including:
an encryptor coupled to a first data input and a first data output of the apparatus, the encryptor to generate encrypted data based on write data received at the first data input,
a first protection bit generator coupled to the first data input, the first protection bit generator to generate an inbound protection bit stream based on the write data, and
a first stream cipher coupled to the first protection bit generator, the first stream cipher to generate write protection metadata based on the inbound protection bit stream, a write address associated with the write data, and a write count associated with the write address.

2. The system of claim 1, wherein the first protection bit generator includes a parity generator and the inbound protection bit stream is to include a single protection bit per encryption block of the encrypted data.

3. The system of claim 1, wherein the first protection bit generator includes one or more of a parity generator or a cyclic redundancy checker and the inbound protection bit stream is to include a plurality of protection bits per encryption block of the encrypted data.

4. The system of claim 1, wherein the datapath protection apparatus further comprises a read path including:
a decryptor coupled to a second data input and a second data output of the apparatus, the decryptor to generate decrypted data based on read data received at the second data input,
a second protection bit generator coupled to the second data output, the second protection bit generator to generate a first outbound protection bit stream based on the decrypted data,
a second stream cipher to generate a second outbound protection bit stream based on a read address associated with the read data, a write count associated with the read address, and outbound protection metadata associated with the read address, and
a comparator coupled to the second protection bit generator and the second stream cipher, the comparator to generate an error signal in response to a difference between the first outbound protection bit stream and the second outbound protection bit stream.

5. The system of claim 4, wherein the second protection bit generator includes one or more of a parity generator or a cyclic redundancy checker.

6. The system of claim 4, wherein the comparator is to determine whether to generate the error signal per each encryption block of the decrypted data.

7. The system of claim 1, further comprising one or more of:
a processor communicatively coupled to the memory;
a display communicatively coupled to the memory;
a network interface communicatively coupled to a processor; or
a battery communicatively coupled to a processor.

8. An apparatus comprising:
a write path including:
an encryptor coupled to a first data input and a first data output of the apparatus, the encryptor to generate encrypted data based on write data received at the first data input,
a first protection bit generator coupled to the first data input, the first protection bit generator to generate an inbound protection bit stream based on the write data, and
a first stream cipher coupled to the first protection bit generator, the first stream cipher to generate write protection metadata based on the inbound protection bit stream, a write address associated with the write data, and a write count associated with the write address.

9. The apparatus of claim 8, wherein the first protection bit generator includes a parity generator and the inbound protection bit stream is to include a single protection bit per encryption block of the encrypted data.

10. The apparatus of claim 8, wherein the first protection bit generator includes one or more of a parity generator or a cyclic redundancy checker and the inbound protection bit stream is to include a plurality of protection bits per encryption block of the encrypted data.

11. The apparatus of claim 8, further including a read path including:
a decryptor coupled to a second data input and a second data output of the apparatus, the decryptor to generate decrypted data based on read data received at the second data input,
a second protection bit generator coupled to the second data output, the second protection bit generator to generate a first outbound protection bit stream based on the decrypted data,
a second stream cipher to generate a second outbound protection bit stream based on a read address associated with the read data, a write count associated with the read address, and outbound protection metadata associated with the read address, and
a comparator coupled to the second protection bit generator and the second stream cipher, the comparator to generate an error signal in response to a difference between the first outbound protection bit stream and the second outbound protection bit stream.

12. The apparatus of claim 11, wherein the second protection bit generator includes one or more of a parity generator or a cyclic redundancy checker.

13. The apparatus of claim 11, wherein the comparator is to determine whether to generate the error signal per each encryption block of the decrypted data.

14. A method comprising:
generating, by an encryptor, encrypted data based on write data received at a first data input of an apparatus;
generating, by a first protection bit generator, an inbound protection bit stream based on the write data; and
generating, by a first stream cipher, write protection metadata based on the inbound protection bit stream, a write address associated with the write data, and a write count associated with the write address.

15. The method of claim 14, wherein the inbound protection bit stream includes a single protection bit per encryption block of the encrypted data.

16. The method of claim 14, wherein the inbound protection bit stream includes a plurality of protection bits per encryption block of the encrypted data.

17. The method of claim 14, further including:
generating, by a decryptor, decrypted data based on read data received at a second data input of the apparatus;
generating, by a second protection bit generator, a first outbound protection bit stream based on the decrypted data;
generating, by a second stream cipher, a second outbound protection bit stream based on a read address associated with the read data, a write count associated with the read address, and outbound protection metadata associated with the read address, and
generating, by a comparator, an error signal in response to a difference between the first outbound protection bit stream and the second outbound protection bit stream.

18. The method of claim 17, wherein the first outbound protection bit stream is generated by one or more of a parity generator or a cyclic redundancy checker.

19. The method of claim 17, further including determining whether to generate the error signal per each encryption block of the decrypted data.

20. At least one non-transitory computer readable storage medium comprising a set of instructions, which when executed by a computing device, cause the computing device to:
generate encrypted data based on write data received at a first input of an apparatus;
generate an inbound protection bit stream based on the write data; and
generate write protection metadata based on the inbound protection bit stream, a write address associated with the write data, and a write count associated with the write address.

21. The at least one non-transitory computer readable storage medium of claim 20, wherein the inbound protection bit stream is to include a single protection bit per encryption block of the encrypted data.

22. The at least one non-transitory computer readable storage medium of claim 20, wherein the inbound protection bit stream is to include a plurality of protection bits per encryption block of the encrypted data.

23. The at least one non-transitory computer readable storage medium of claim 20, wherein the instructions, when executed, further cause a computing device to:
generate decrypted data based on read data received at a second data input of the apparatus;
generate a first outbound protection bit stream based on the decrypted data; and
generate an error signal in response to a difference between the first outbound protection bit stream and the second outbound protection bit stream.

24. The at least one non-transitory computer readable storage medium of claim 23, wherein the first outbound protection bit stream is to be generated by one or more of a parity generator or a cyclic redundancy checker.

25. The at least one non-transitory computer readable storage medium of claim 23, wherein the instructions, when executed, further cause a computing device to determine whether to generate the error signal per each encryption block of the decrypted data.
